(19) United States
(12) Patent Application Publication
(10) Pub. No.: US 2015/0213260 A1
(43) Pub. Date: Jul. 30, 2015

(54) DEVICE AND METHOD FOR DETECTING VULNERABILITY ATTACK IN PROGRAM

(71) Applicant: IGLOO SECURITY, INC., Seoul (KR)

(72) Inventor: Ji-Hoon Park, Seoul (KR)

(21) Appl. No.: 14/604,374

(22) Filed: Jan. 23, 2015

(30) Foreign Application Priority Data
Jan. 27, 2014 (KR) 10-2014-0009869

(51) Int. Cl. G06F 21/55; G06F 21/56

(52) U.S. Cl. CPC G06F 21/554; G06F 21/56; G06F 2221/033

(57) ABSTRACT

A device and method for detecting a vulnerability attack in a program, includes a hooking processing unit that suspends execution of a process by hooking a function when the process is executed and calls the function to perform a specific task; an information collecting unit that collects and outputs information about call stack return address by checking a call stack of the function hooked by the hooking processing unit; and an information determining unit that detects a malicious behavior by analyzing the call stack return address information output from the information collecting unit. The device and method for detecting a vulnerability attack in a program may prevent execution of a malicious code by detecting erroneous access or code execution in a whole area of memory.

### CROSS-REFERENCE TO RELATED APPLICATIONS

This application claims priority to Korean Application No. 10-2014-0009869, filed Jan. 27, 2014, which is incorporated herein by specific reference.

### BACKGROUND OF THE INVENTION

1. Field of the Invention

The present invention generally relates to a device and method for preventing execution of malicious codes that use vulnerability in a program. More particularly, the present invention relates to a device and method for detecting a vulnerability attack in a program, which includes: a hooking processing unit that suspends execution of a process by hooking a function when the process is executed and calls the function to perform a specific task; an information collecting unit that collects and outputs information about a call stack return address by checking a call stack of the function hooked by the hooking processing unit; and an information determining unit that detects a malicious behavior by analyzing the call stack return address information output from the information collecting unit. Accordingly, the device and method for detecting a vulnerability attack in a program may prevent execution of a malicious code by detecting erroneous access or code execution in a whole area of memory.

2. Description of the Related Art

As personal information or information about organizations is stored in computers, and computing environments such as information exchange through Internet, wireless networks, and the like are varied and complex, information security measures have become more significant. Particularly, it is very important to prevent damage caused by malware that flows from the outside via various routes. Malware means harmful software with malicious intent that damages computer users. Malware includes computer viruses, worms, trojan horses, spyware, adware, and the like, and may cause problems including excessive network traffic, performance degradation in a system, deletion of files, automatic sending of emails, personal information leakage, remote control of a user's computer, and the like.

Departing from a general method of distributing malware in which an execution file extension is hidden to make a user unaware that the file is execution file of an operating system, a method for distributing malware that attacks vulnerability in a program is now widely used. By malware using vulnerability of a specific program, for example, by malware using vulnerability of Internet Explorer, when a user enters a specific webpage, the user's computer may be infected with the malware even though the user does nothing. Attacking vulnerability in a program involves finding bugs in the program and using the bugs to change the code execution flow of the program into the flow desired by an attacker. In other words, normally, a bug does not occur in a vulnerable code, but abnormal input data may be inserted to the vulnerable code so that the bug always occurs in that code. In this case, the input data includes malicious codes and data causing the bug. Accordingly, when a process processes the input data, the bug occurs and due to the bug, code execution flow of the program is moved to a malicious code in the input data, thus causing execution of the malicious code.

Consequently, execution of malicious codes may be prevented by a method of detecting hacking, described in the following patent document.

Korean Patent Application Publication No. 10-2003-0046581 (2003 Jun. 18) “Method for detecting hacking of real-time buffer overflow”

However, to detect a malicious behavior, the method of detecting hacking determines whether a return value is in a stack area when a system call (API function call) is generated. In other words, as the method only defends the stack area, a malicious code avoiding the area may not be detected.

Also, a device and method for determining whether a non-executable file is malicious depending on whether or not a memory area indicated by the execution address has an execution attribute, may prevent execution of codes in a normal memory area such as a stack, a heap, and the like. However, when the execution address has the execution attribute, the device and method determines that it is a normal operation. Therefore, an attack like Return-Oriented Programming (ROP) that is executed in a code area cannot be defended.

### SUMMARY OF THE INVENTION

Accordingly, the present invention has been made keeping in mind the above problems, and an object of the present invention is to provide a device and method for detecting a vulnerability attack in a program, which prevents behaviors executing a malicious code using vulnerability of a program through behavior-based diagnosis rather than through signature-based diagnosis.

Another object of the present invention is to provide a device and method for detecting a vulnerability attack in a program, which suspends execution of a process by hooking a function when the process is executed and calls the function to perform a specific task; checks a call stack of the hooked function and collects information about the call stack return address; and analyzes the call stack return address information, to detect erroneous access or code execution in a whole area of memory to prevent execution of a malicious code.

A further object of the present invention is to provide a device and method for detecting a vulnerability attack in a program, which may detect dozens of function call mutes by hooking only one function using a call stack detection method.

Yet another object of the present invention is to provide a device and method for detecting a vulnerability attack in a program, which more effectively prevent malicious behaviors by enabling permanent DEP on a process; preempting addresses of a heap area; and relocating base addresses of dynamic modules that are loaded in a process.

Still another object of the present invention is to provide a device and method for detecting a vulnerability attack in a program, which facilitates an operation of a diagnosis processing unit through filtering call stack return address information by a filtering unit.

In order to accomplish the above object, the present invention is implemented by embodiments configured as follows.

According to an embodiment of the present invention, a device for detecting a vulnerability attack in a program, includes: a hooking processing unit for suspending execution of a process by hooking a function when the process is executed and calls the function to perform a specific task; an information collecting unit for collecting and outputting call stack return address information by checking a call stack of the function hooked by the hooking processing unit; and an information determining unit for preventing execution of a malicious code by detecting a malicious behavior from analysis of the call stack return information that is output from the information collecting unit.

According to another embodiment of the present invention, in the device for detecting a vulnerability attack in a program, the call stack return address information includes: a return address of every function located on every function call mute that calls the hooked function; an attribute of memory that includes the return address; and a name of a module that includes the return address.

According to a further embodiment of the present invention, in the device for detecting a vulnerability attack in a program, the information determining unit includes: a first diagnosis unit for determining by analyzing call stack return address information whether a return address is in a code area, and for determining that there is a malicious behavior when the return address is not in the code area; and a second diagnosis unit for determining by analyzing the call stack return address information whether a previous instruction of an instruction that a return address indicates is a function call instruction, and for determining that there is a malicious behavior when the previous instruction of the instruction that the return address indicates is not a function call instruction.

According to yet another embodiment of the present invention, in the device for detecting a vulnerability attack in a program, the information determining unit further includes a processing unit for storing both diagnosis information and a log file in a disk and terminating a process so as not to execute any more codes when anyone of both the first and second diagnosis unit detects a malicious behavior, and for resuming execution of the suspended process when neither the first nor second diagnosis unit detect a malicious behavior.

According to still another embodiment of the present invention, in the device for detecting a vulnerability attack in a program, the information determining unit further includes a filtering unit for skipping a determination of the first and second diagnosis unit when the call stack return address information corresponds to criteria for exception handling by comparing the criteria for exception handling with the call stack return address information output from the information collecting unit. The filtering unit does exception handling when a return address of the call stack return address information is in memory that is not allocated in a process address space; when the return address of the call stack return address is in a stack area of memory; when the return address of the call stack return address information is in a whitelist; and when an attribute of the return address of the call stack return address information is Write attribute.

According to another embodiment of the present invention, the device for detecting a vulnerability attack in a program further includes a security configuration unit for checking and configuring a security state of a process before execution of the process. The security configuration unit further includes a check unit for checking and enabling DEP of an operating system; and an execution unit for enabling permanent DEP on a process to prevent execution of a code in a non-executable memory area when the check unit confirms that DEP of the operating system is enabled.

According to another embodiment of the present invention, in the device for detecting a vulnerability attack in a program, the execution unit enables permanent DEP on a process, which cannot be disabled by a malicious behavior, by enabling DEP on the process in a state that the process is created if DEP is not enabled on the process, and by disabling and then enabling DEP if DEP is enabled on the process.

According to another embodiment of the present invention, in the device for detecting a vulnerability attack in a program, the security configuration unit further includes an address preemption unit for preempting an address of a heap area, which is used for a malicious behavior by a heap spray attack.

According to another embodiment of the present invention, the device for detecting a vulnerability attack in a program further includes a relocation unit for relocating, in a function that loads a dynamic module, a base address of a dynamic module loaded in a process by analyzing information about the function hooked by the hooking processing unit. The relocation unit determines whether a relocation option of the dynamic module is enabled, and when the relocation option is disabled, the relocation unit collects the base address of the dynamic module from the function loading the dynamic module and allocates memory at the base address.

According to another embodiment of the present invention, a method for detecting a vulnerability attack in a program includes a hooking processing operation for suspending execution of a process by hooking a function when the process is executed and calls the function to perform a specific task; an information collecting operation for collecting and outputting call stack return address information by checking a call stack of the function hooked by the hooking processing operation; and an diagnosis processing operation for preventing execution of a malicious code by detecting a malicious behavior from analysis of the call stack return address information output from the information collecting operation.

According to another embodiment of the present invention, in the method for detecting a vulnerability attack in a program, the call stack return address information includes a return address of every function located on every function call route that calls the hooked function; an attribute of memory that includes the return address; and a name of a module that includes the return address. The diagnosis processing operation further includes: a first diagnosis operation for determining by analyzing call stack return address information whether a return address is in a code area, and for determining that there is a malicious behavior when the return address is not in the code area; and a second diagnosis operation for determining by analyzing the call stack return address information whether a previous instruction of an instruction that a return address indicates is a function call instruction, and for determining that there is a malicious behavior when the previous instruction of the instruction that the return address indicates is not a function call instruction.

According to another embodiment of the present invention, the method for detecting a vulnerability attack in a program further includes a filtering operation, before the diagnosis processing operation, for skipping a determination of the diagnosis processing operation when the call stack return address information corresponds to criteria for exception handling by comparing the criteria for exception handling with the call stack return address information output from the information collecting operation. In the filtering operation, exception handling is done when a return address of the call stack return address information is memory that is not allocated in a process address space, when the return address of the call stack return address is in a stack area of memory, when the return address of the call stack return address information is in a whitelist, and when an attribute of the return address of the call stack return address information is Write attribute.

According to another embodiment of the present invention, the method for detecting a vulnerability attack in a program further includes a security configuring operation for checking and configuring a security state of a process before the hooking processing operation. The security configuring operation further includes: a checking operation for checking and enabling DEP of an operating system; an executing operation for enabling permanent DEP on a process to prevent execution of a code in a non-executable memory area when confirming in the checking operating that DEP of the operating system is enabled; and an address preempting operation for preempting an address of a heap area, which is used for a malicious behavior by a heap spray attack, after permanent DEP is enabled in the executing operation. In the executing operation, permanent DEP, which cannot be disabled by a malicious behavior, is enabled on a process by enabling DEP on the process in a state that the process is created if DEP is not enabled on the process, and by disabling and then enabling DEP when DEP is enabled on the process.

According to another embodiment of the present invention, the method for detecting a vulnerability attack in a program further includes a relocating operation for relocating a base address of a dynamic module loaded in a process by analyzing the function hooked by the hooking processing operation. In the relocating operation, whether a relocation option of the dynamic module is enabled is determined, and when the relocation option is disabled, the base address of the dynamic module is collected from the function loading the dynamic module and memory at the base address is allocated.

The present invention may obtain the following effects based on the above embodiments and the configurations, combinations and relations that will be described later.

Through behavior-based diagnosis rather than through signature-based diagnosis, the present invention may prevent behaviors executing a malicious code that uses vulnerability of a program.

Also, as the present invention suspends execution of a process by hooking a function when the process is executed and calls the function to perform a specific task, checks a call stack of the hooked function and collects information about the call stack return address, and analyzes the call stack return address information, it may detect erroneous access or code execution in a whole area of memory so as to have an effect of preventing execution of a malicious code.

Also, the present invention may detect dozens of function call routes by hooking only one function using a call stack detection method.

Also, the present invention may more effectively prevent malicious behaviors by enabling permanent DEP on a process; preempting addresses of a heap area; and relocating base addresses of dynamic modules that are loaded in a process.

Also, the present invention has an effect of facilitating an operation of a diagnosis processing unit through filtering call stack return address information by a filtering unit.

### BREW DESCRIPTION OF THE DRAWINGS

The above and other objects, features and other advantages of the present invention will be more clearly understood from the following detailed description taken in conjunction with the accompanying drawings, in which:

FIG. 1 is a block diagram of a device for detecting a vulnerability attack in a program, according to an embodiment of the present invention;

FIG. 2 is a block diagram illustrating a detailed configuration of a security configuration unit;

FIG. 3 is a block diagram illustrating a detailed configuration of a process review unit;

FIG. 4 is a reference diagram for explaining a general vulnerability attack;

FIG. 5 is a reference diagram for explaining ROP attack that uses vulnerability in a program;

FIG. 6 is a reference diagram for explaining a heap spray attack that uses vulnerability in a program;

FIG. 7 is a reference diagram illustrating function call routes for explaining an information collecting unit in FIG. 3;

FIGS. 8 and 9 are reference diagrams for explaining a second diagnosis unit in FIG. 3;

FIG. 10 is a flow diagram for explaining an operation of a relocation unit in FIG. 1; and

FIG. 11 is a flow diagram of a method for detecting a vulnerability attack in a program, according to another embodiment of the present invention.

### DESCRIPTION OF THE PREFERRED EMBODIMENTS

Hereinafter, embodiments of a device and method for detecting a vulnerability attack in a program, according to the present invention will be described referring to the accompanying drawings. To prevent obfuscating the description of the present invention, detailed description of structures or functions known to the public shall be omitted. It will be understood that, throughout the specification, unless explicitly stated to the contrary, the term “comprise” and its conjugations such as “comprises” and “comprising” should be interpreted as including any stated elements but not necessarily excluding other elements. In addition, the terms “section”, “device”, “module”, and the like used herein refer to a unit which can be embodied as hardware, software, or a combination thereof, for processing at least one function and performing an operation.

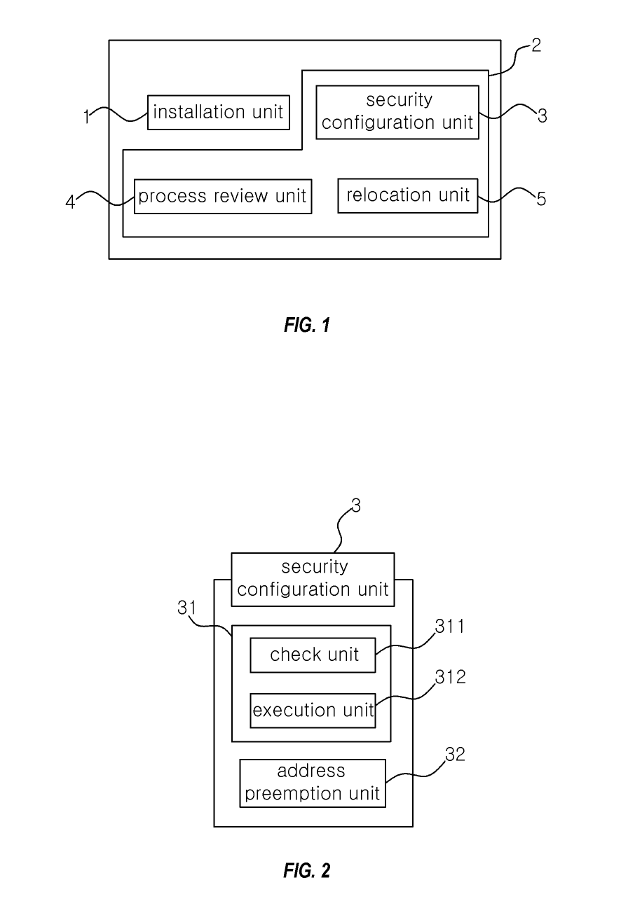

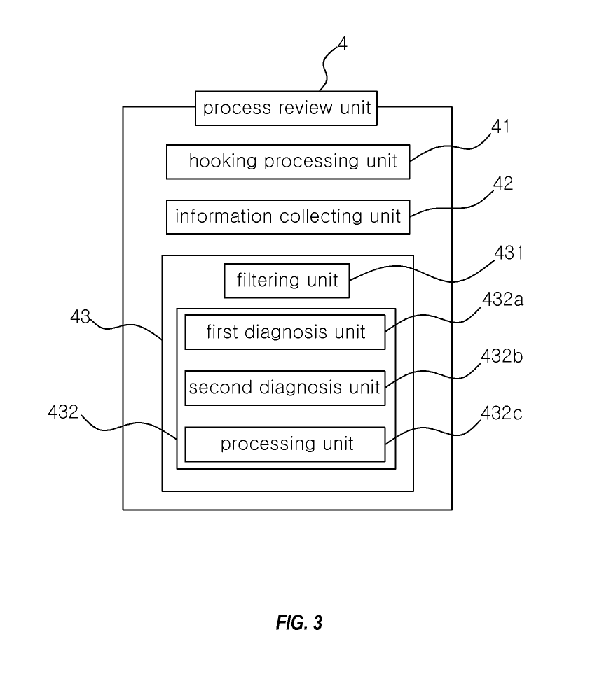

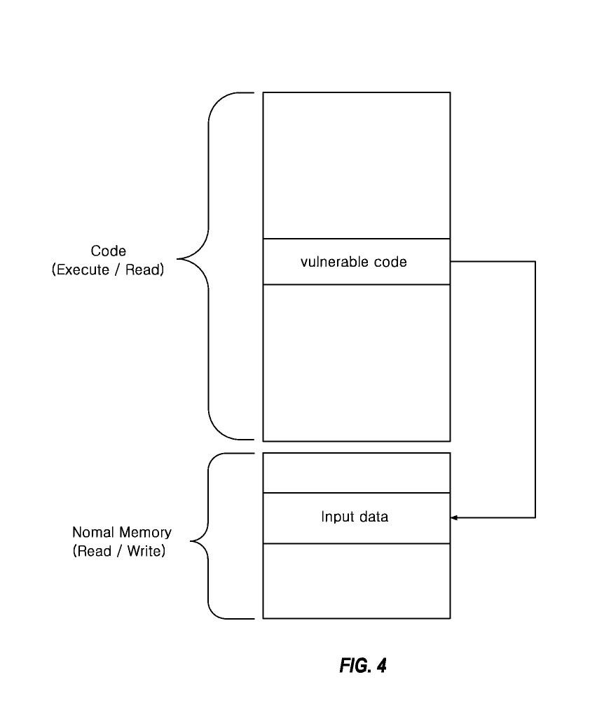

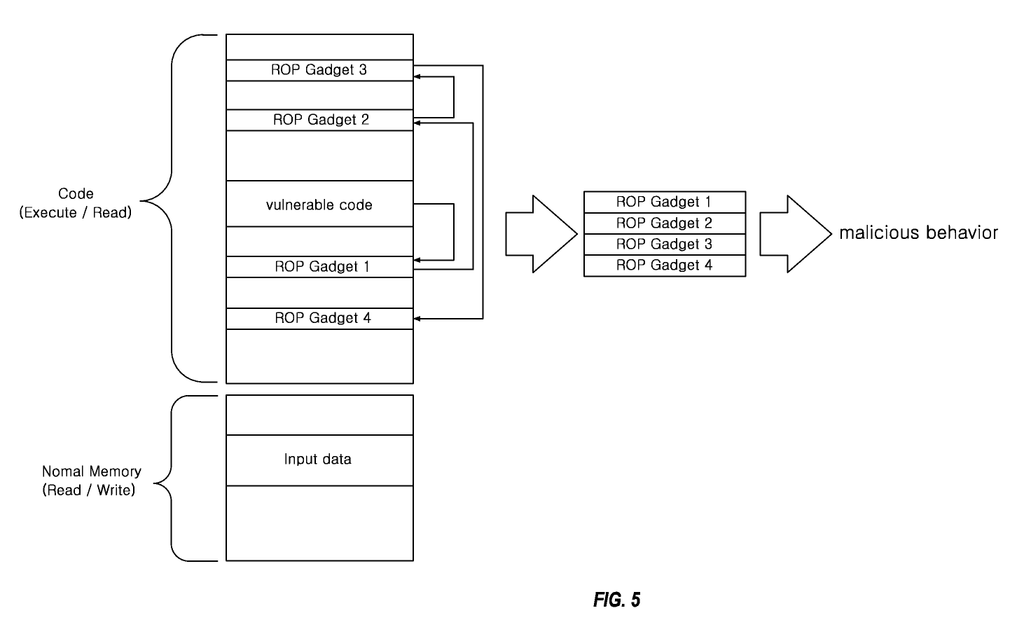

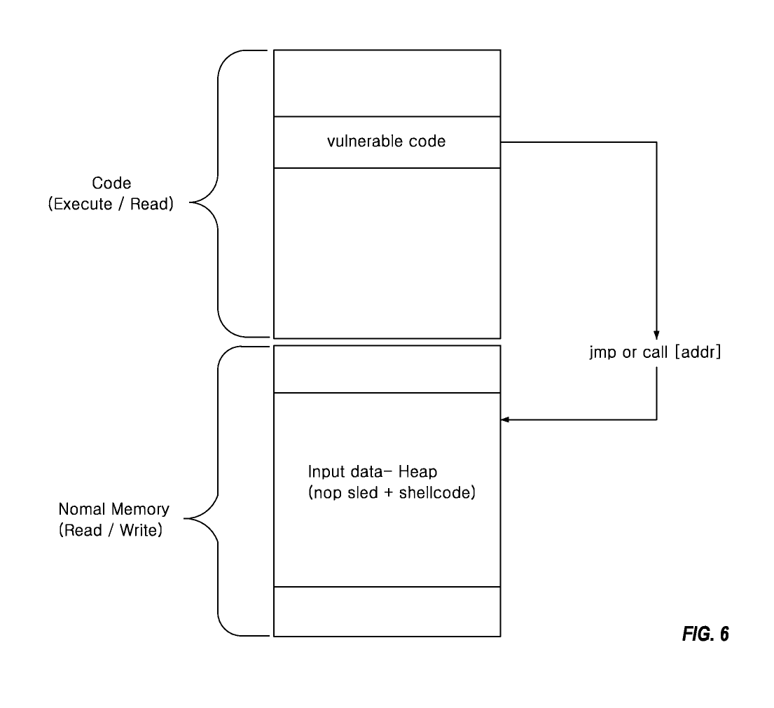

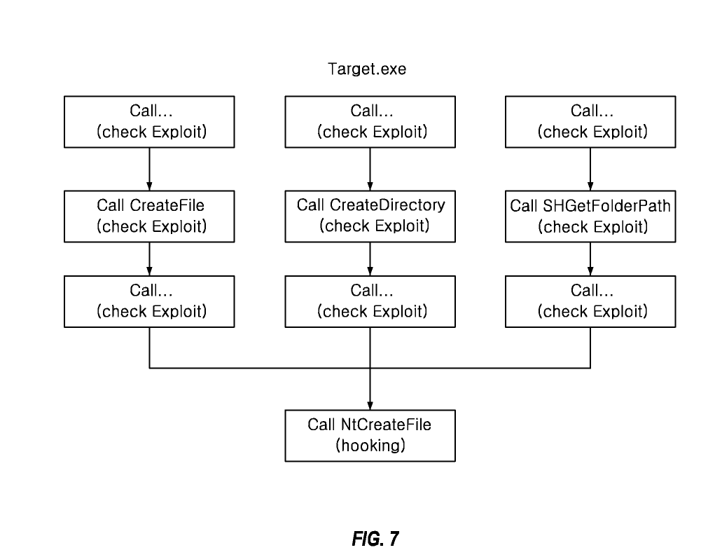

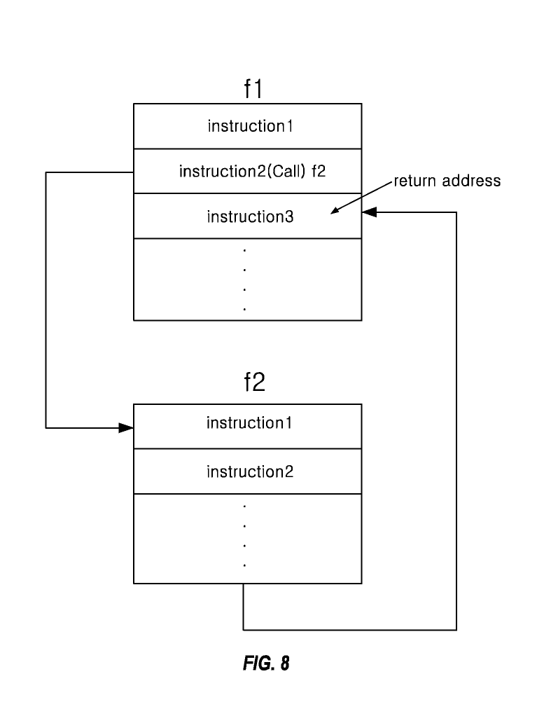

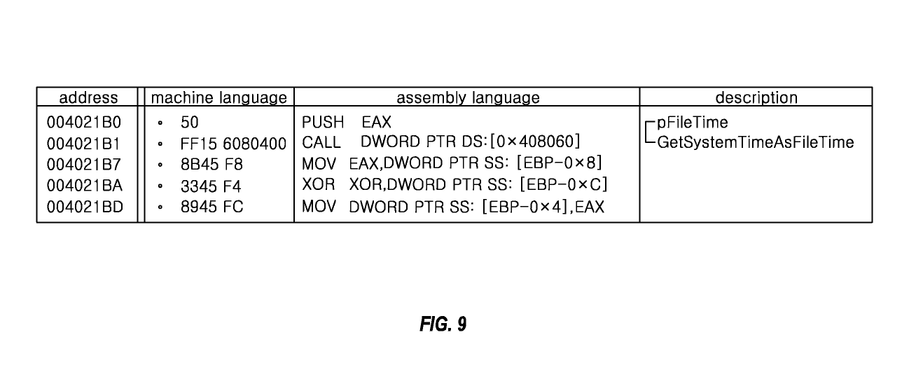

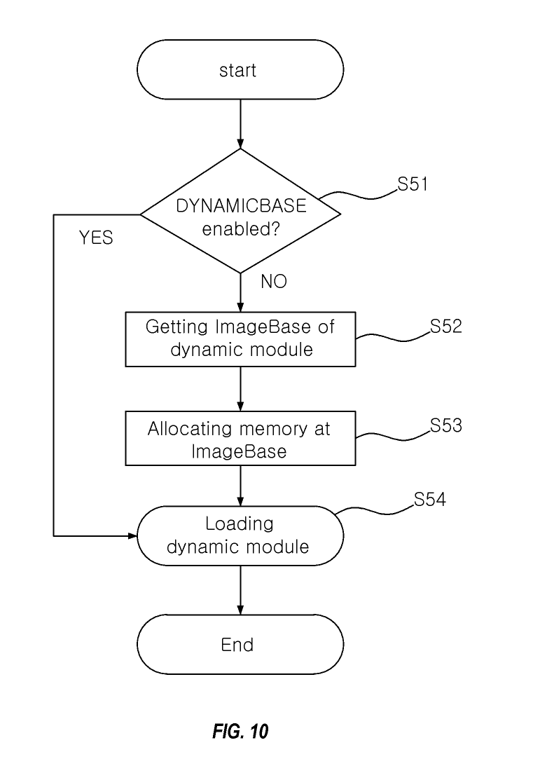

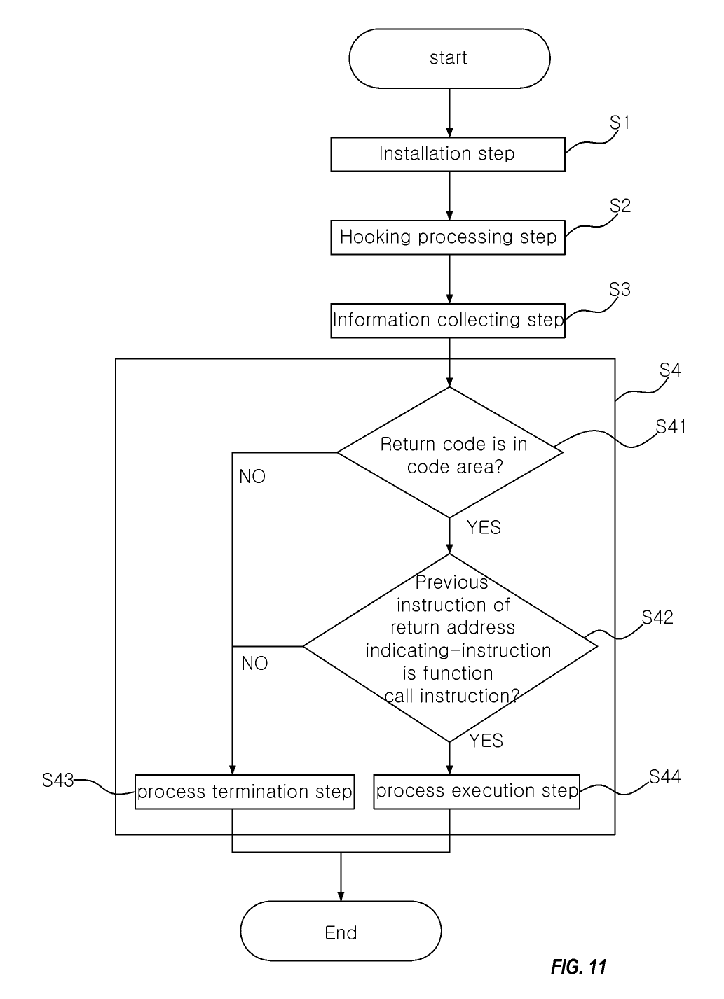

FIG. 1 is a block diagram of a device for detecting a vulnerability attack in a program, according to an embodiment of the present invention; FIG. 2 is a block diagram illustrating a detailed configuration of a security configuration unit; FIG. 3 is a block diagram illustrating a detailed configuration of a process review unit; FIG. 4 is a reference diagram for explaining a general vulnerability attack; FIG. 5 is a reference diagram for explaining ROP attack that uses vulnerability in a program; FIG. 6 is a reference diagram for explaining a heap spray attack that uses vulnerability in a program; FIG. 7 is a reference diagram illustrating function call mutes for explaining an information collecting unit in FIG. 3; FIGS. 8 and 9 are reference diagrams for explaining a second diagnosis unit in FIG. 3; FIG. 10 is a flow diagram for explaining an operation of a relocation unit in FIG. 1; and FIG. 11 is a flow diagram of a method for detecting a vulnerability attack in a program, according to another embodiment of the present invention.

Describing a device for detecting a vulnerability attack in a program referring to FIGS. 1 to 10, the device includes an installation unit 1 for loading a protection unit in a process; and the protection unit 2, loaded in the process by the installation unit, for detecting a vulnerability attack in a program.

The installation unit 1 is configured to load the protection unit 2 in the process. The installation unit 1 is a device driver that operates in the kernel. Using a callback routine when the process is created, the installation unit 1 installs the protection unit 2 after the process is created but in a state that the process is not executed. For example, using Asynchronous Procedure Calls, the installation unit 1 may load the protection unit 2 in the process. The creation of the process generally means that the process is operating. When a process is created, the process has its own space in memory. For example, when an execution file like Notepad.exe is executed and then loaded in the memory, the Notepad process is created. Also, the execution of the process means that the process executes a code to perform a specific task (for example, file creation, external communication, etc.) after the process is created.

The protection unit 2, loaded in the process by the installation unit 1 after the process is created but in a state that the process is not executed, is configured to detect and defend a vulnerability attack in a program. The protection unit 2 includes a security configuration unit 3, a process review unit 4, and a relocation unit 5.

To diagnose and prevent a vulnerability attack in a program (hereinafter, called ‘malicious behavior’), the security configuration unit 3 checks and configures a security state of a process before execution of the process. The security configuration unit 3 includes a permanent DEP setting unit 31, an address preemption unit 32, and the like.

The permanent DEP setting unit 31, configured to enable permanent Data Execution Prevention (DEP) on a process, includes a check unit 311, an execution unit 312, and the like.

The check unit 311 checks and enables DEP of an operating system. Data Execution Prevention (DEP) is a defense method that prevents execution of code in a non-executable area of memory. The DEP may be enabled on each process. However, when DEP of an operating system is disabled, DEP is not operated even though DEP is enabled on each process. Therefore, before enabling DEP on each process, it is necessary for the check unit 311 to check whether DEP of the operating system is enabled and to enable DEP of the operating system if it is disabled.

When the check unit 311 confirms that DEP of the operating system is enabled, the execution unit 312 enables permanent DEP on a process to prevent execution of a code in a non-executable area of memory. Generally, if a program is generated with an option enabling DEP in a compiler, when the program is executed and becomes a process, DEP is enabled on the process. However, in this case, it is possible to disable DEP on the process. Accordingly, it is necessary to enable permanent DEP by enabling DEP on the process after the process is created. If DEP is not enabled on the process, DEP is enabled on the process in a state that the process is created. If DEP is enabled on the process, DEP is disabled and then enabled on the process so as to enable permanent DEP that cannot be disabled by a malicious behavior. In the present application, a normal memory area means a memory area excluding a code area, and the normal memory area includes a data area, a stack, a heap, and the like. In a normal case, because a code is executed in a code area of memory, a normal memory area is represented as a non-executable memory area.

The reason why permanent DEP is enabled on the process is that a malicious behavior as illustrated in FIG. 4 operates as follows. When input data (for example, input data may be a document file in case of a document reader program, or may be chatting messages in case of a chatting program) is input, the process processes the input data. In this case, the input data attacks a vulnerable code, and thus code execution flow is moved from the code area to a location of the input data in the normal memory area. Accordingly, the code in the normal memory area rather than in the code area is executed, thus a malicious code included in the input data is executed. However, if DEP is enabled on the process, the malicious code in the normal memory area is not executed.

However, even though a code cannot be executed in a normal memory area, an attack called Return Oriented Programming (ROP) may evade a general DEP function by performing malicious behaviors in a code area. As illustrated in FIG. 5, ROP generates malicious behavior flow using code sections (gadget) in the code area. In other words, as ROP combines instructions in the code area to generate a malicious code, a malicious behavior happens even though DEP is enabled on a process. However, because it is not easy to find code sections and to generate a meaningful combination of the code sections, it is difficult to carry many malicious behaviors using ROP attack. Accordingly, using ROP attack, attackers generates an operation that calls a function for disabling DEP on the process. In other words, the attackers disable DEP on the process, and then move the execution flow to a malicious code in the normal memory area to execute the malicious code. However, as permanent DEP is enabled on the process by the permanent DEP setting unit, DEP on the process cannot be disabled in spite of the ROP attack. Accordingly, execution of a code in a normal memory area may be prevented.

To defend a heap spray attack, the address preemption unit 32 is configured to preempt addresses of a heap area in a normal memory area, the addresses of a heap area being used for malicious behaviors. Describing a heap spray attack referring to FIG. 6, the heap spray attack fills the heap area of the memory with Nop Sleds that operate a meaningless task, and inserts shell codes in between Nop Sleds. Then, the heap spray attack executes a jump or call instruction in vulnerable codes to move control to a desired address, thus a malicious code (shell code) is executed. To execute the malicious code, execution just slides down the Nop Sleds, and a value used for the Nop Sled becomes an address to which control is moved by the jump or call instruction. Consequently, if the address of the heap area (the value of Nop Sled), which is used for malicious behaviors by the heap spray attack, is preempted, it is possible to prevent execution of the malicious code. Giving a concrete example, an instruction as “ADC AL, 0x14” only affects an AL register, but even if the instruction is executed several times, it may not affect a code (malicious code) that will be executed later. In this case, the binary value of the instruction is “0x14”, and “0x14” can be used as a Nop Sled. In the heap spray attack, a value used for the Nop Sled becomes an address to which control is moved by a jump or call instruction. In the above example, as 0x14 is used for the Nop Sled, the address to which control is moved becomes 0x14141414. If the address of 0x14141414 has been preempted, a heap area at the address cannot be allocated. Thus, skipping over a page including the address of 0x14141414, a heap area at another address is allocated. In the above case, when jumping or calling to the address of 0x14141414 due to vulnerability of the program, the area at the address is allocated (preempted) by the address preemption unit. Therefore, execution of a malicious code is prevented.

When a process is executed and calls a specific function to perform a specific task, the process review unit 4 operates as follows to prevent execution of malicious codes. The process review unit suspends execution of the process by hooking the function, collects call stack return address information by checking a call stack of the hooked function, and analyzes the call stack return address information to detect a malicious behavior. The process review unit 4 includes a hooking processing unit 41, an information collecting unit 42, an information determining unit 43, and the like. As the security configuration unit 3 and the process review unit 4 use different methods to prevent a malicious behavior, it is not necessary that the security configuration unit 3 operates before the process review unit 4 operates. Furthermore, without the security configuration unit 3, it is possible to prevent a malicious behavior only by operation of the process review unit 4.

When a process is executed and calls a specific function to perform a specific task, the hooking processing unit 41 is configured to suspend the execution of the process by hooking the function. The hooking means technology that intercepts the function call process and allows a desired task to be performed. Each process performs various tasks for its own purpose, and to perform a specific task, the process is executed and calls a specific function. Accordingly, if the specific function is hooked, it is possible to suspend the execution of the process and to perform a desired task (determining whether code execution flow of the program is controlled by a malicious behavior). For example, if the program is a document editor, it calls “CreateFile” function to create a file on a disk. If the program is a bowser, it calls “Connect” function to communicate with external resources. In this case, creating a disk file or communication with the external resources can be suspended by hooking the functions such as CreateFile, Connect, and the like. In other words, by hooking functions that are called from the execution of the processes, it is possible to monitor actions including creating a process, modifying process information, accepting a process handle, creating a file, accessing a registry, accessing system information, memory allocation, modifying memory attributes, communication with external resources, downloading files, and the like.

The information collecting unit 42 is configured to collect and output call stack return address information by checking a call stack of the function hooked by the hooking processing unit 41. The call stack return address information includes: a return address of every function located on the function call routes of functions that call the hooked function; an attribute of memory in which the return address is included (for example, protection right of memory, status values, etc.); module names (for example, hwp, exe, dll); ImageBase address for loading a dynamic module; and the like. Through the call stack of the hooked function, every function call mute to reach the specific function may be recognized. For example, if “CreateFile” function is enrolled as a monitoring (hooking) target by the process review unit 4, when “main” function internally calls “func1” function; “func1” calls “func2” function; and “func2” calls the “CreateFile” function, the information collecting unit 42 gets a call stack that sequentially stores a next address of the address in which the “CreateFile” function is called; a next address of the address in which the “func2” function is called; and a next address of the address in which the “func1” function is called. In other words, the next address of the address in which the function is called is referred to as a return address, and the information collecting unit 42 continuously collects return addresses of each function call. Because the call stack has only a list of return addresses, the information collecting unit 42 completes call stack return address information by collecting an attribute of memory in which the return address is included (for example, protection right of memory, status values, etc.), module names (for example, hwp, exe, dll), ImageBase address for loading a dynamic module, and the like from the memory. Then the information collecting unit 42 outputs the call stack return address information.

Using the call stack, the information collecting unit 42 collects and outputs call stack return address information that includes information of every function located on the function call mutes of the monitoring target function. Therefore, the information determining unit 43 may diagnose every upper level caller of the monitoring target function, and effectively prevent malicious behavior. Specifically, as illustrated in FIG. 7, even though only NtCreateFile function is hooked, whether the function call (code) flow is malicious code flow may be checked for every upper level caller of NtCreateFile function. In FIG. 7, three function call mutes are illustrated, but there may be dozens of function call mutes in which NtCreateFile function is called, and all the functions on the mutes are checked. In other words, when checking dozens of function call mutes, dozens of functions should be respectively hooked if not using a call stack detection method. However, if using the call stack detection method, dozens of function call stacks can be checked by hooking only one function.

To prevent execution of a malicious code, the information determining unit 43 is configured to detect a malicious behavior by analyzing call stack return address information. The information determining unit 43 includes a filtering unit 431, a diagnosis processing unit 432, and the like.

The filtering unit 431 compares predetermined criteria for exception handling with call stack return address information output from the information collecting unit 42. If the call stack return address information corresponds to the criteria for exception handling, the filtering unit 431 filters the information as an exception handling case of the diagnosis processing unit 432. Describing the criteria for exception handling of the filtering unit 431, for example, when a return address in call stack return address information is in memory that is not allocated as a process address space, when a return address in call stack return address information is in a stack area of memory, when a return address in call stack return address information is in a whitelist, and when an attribute of a return address in call stack return address information is Write attribute, the exception handling is done.

Generally, as an area including a return address is an area in which codes are executed, an attribute of the memory including the return address can be normally obtained. That the memory attribute is normal means that the memory address including the return address indicates a normally allocated area in the memory. However, when practically following a call stack, it is unclear how many return addresses should be obtained. Therefore, a wrong return address may be obtained while getting the return addresses. Consequently, when the return address is in memory that is not allocated as a process address space, exception handling is done.

Also, as permanent DEP is enabled on a process by the security configuration unit 3, a code cannot be executed on a stack area. Nevertheless, if the collected return address is included in the stack area, it is not caused by malicious behaviors. Instead, it is determined that a wrong return address has been obtained. Consequently, when the return address is included in a stack area of memory, exception handling is done.

Also, in case of general binary files, a code is executed only in a code area. However, system-dependent programs like Anti-Viruses perform a lot of tasks that seem like a malicious behavior. For example, generally, a code area is allowed to have only Execute and Read permission. However, if Write permission is additionally given to modify the code area, the code area has Execute/Read/Write permission. In this case, if an operation of creating a file is performed in that area, the operation is caught by a hooking monitoring routine, and the return address is obtained. Then, when checking the memory attribute of the return address, if the attribute corresponds to Execute/Read/Write permission, it is wrongly determined as a malicious behavior. However, in the above description, as the operation of giving Write permission to the code area is processed by normal flow of the program, the operation is intended by a developer. Therefore, if changing the attribute of the memory into Execute/Read/Write permission is processed by normal flow of the program, the memory whose attributes is changed is enrolled as memory included in a range of White Addresses. Consequently, if the return address is included in the range of White Addresses, the information determining unit determines that the operation is processed by normal flow of a program. Additionally, in case of allocating memory with Execute/Read/Write permission in normal flow of a program, the memory address is enrolled in a White Address to avoid a wrong determination. Consequently, when the return address is in a White Address, exception handling is done.

Also, if a specific area on a file already has Execute/Read/Write permission, it is understood that a developer has intentionally given permission. However, in this case, because the attribute of the memory is not changed by the code, it is not caught by the exception handling case that is processed when a return address is a White address. Therefore, when a memory area including a return address has Execute/Read/Write permission, the filtering unit finds the file on a disk, which is matched with the memory area, and gets the attributes of the area from the file. If the area has Execute/Read/Write permission on the file, the filtering unit determines that it is normal. Consequently, when an attribute of an area including a return address is Write permission, exception handling is done.

To prevent execution of a malicious code, the diagnosis processing unit 432 is configured to detect a malicious behavior by analyzing the call stack return address information filtered by the filtering unit 431. The diagnosis processing unit 432 includes: a first diagnosis unit 432a for determining whether a return address is in a code area; a second diagnosis unit 432b for determining whether a previous instruction of the instruction indicated by the return address is a function call instruction; and a processing unit 432c for determining whether to suspend execution of a process according to the determinations of the first diagnosis unit 432a and second diagnosis unit 432b. The filtering unit 431 filters the call stack return address information to facilitate operation of the diagnosis processing unit 431. Accordingly, without the filtering unit 431, the present invention may prevent execution of a malicious code by detecting malicious behaviors through analysis of the call stack return address information that is output from the information collecting unit 42.

The first diagnosis unit 432a is configured to analyze call stack return address information to determine whether a return address is in a code area. If the return address is not in the code area, the first diagnosis unit 432a determines that there is a malicious behavior. Generally, a code is executed only in a code area. However, due to vulnerability of a program, code flow may be changed and moved to a normal memory area. In this case, if an operation like creating a file is performed, as creating a file is performed in the normal memory area, any return address in the call stack return address information may be included in the normal memory area. Accordingly, the first diagnosis unit 432a may detect the malicious behavior.

The second diagnosis unit 432b is configured to analyze call stack return address information to determine whether a previous instruction of the instruction that a return address indicates is a function call instruction. If the previous instruction of the instruction that the return address indicates is not a function call instruction, the second diagnosis unit 432b determines that there is a malicious behavior. Specifically, the second diagnosis unit 432b checks a return address in the call stack return address information, and determines from a memory whether a previous instruction of the instruction that the return address indicates is a function call instruction. FIG. 8 illustrates one example of the function execution flow. Referring to FIG. 8, function f1 sequentially executes instruction1 and instruction2, and by instruction2 that calls function f2, instructions in f2 are sequentially executed. After execution of the instructions in f2, instruction3 in f1, which is located in the return address (next address of the address in which f2 is called), is executed. In this case, the second diagnosis unit 432b detects a malicious behavior by determining whether instruction2, the previous instruction of instruction3 that the return address indicates, is a function call instruction. As described above, ROP attack makes a malicious code by combining code sections (gadget), and it is highly probable that the previous instruction of a code section is not a function call instruction. Consequently, the second diagnosis unit 432b may prevent execution of the code sections. Specifically, FIG. 9 illustrates flow of function call instructions in assembly language. As shown in FIG. 9, when “GetSystemTimeAsFileTime” function is called, the return address is 0x004021B7. In other words, the next instruction of “GetSystemTimeAsFileTime” is located at the address 0x004021B7. Therefore, if the previous instruction of the instruction that the return address indicates is not a function call instruction, it is not determined as normal flow.

According to the determinations of the first diagnosis unit 432a and second diagnosis unit 432b, the processing unit 432c determines whether to suspend execution of a process. When any one of both the first diagnosis unit 432a and the second diagnosis unit 432b detects a malicious behavior, the processing unit 432c stores both the diagnosis information and a log file onto a disk and terminates the process so as not to execute any more codes. If neither the first diagnosis unit 432a nor second diagnosis unit 432b detect a malicious behavior, the processing unit 432c resumes the suspended process.

The relocation unit 5 is configured to analyze information about the function hooked by the hooking process unit 41 (a function related to loading of a dynamic module) so as to relocate a base address of a dynamic module that is loaded in a process. The dynamic module (for example, dll, ocx, and the like) is executed dependent on execution file (for example, exe) that is independently executed and creates a process. When a relocation option (DYNAM ICBASE) is enabled in the dynamic module, the dynamic module is loaded to different ImageBase address whenever it is loaded to memory. Regardless of the relocation option, if the memory at the address to which the dynamic module is loaded is not available, the dynamic module is loaded to a different address. Consequently, as shown in FIG. 10, the relocation unit 5 determines whether the relocation option of the dynamic module is enabled (S51). Then, if the relocation option is disabled, the base address of the dynamic module is collected (S52) and memory at the base address is allocated (S53). Regardless of enabling the relocation option of the dynamic module, if the memory is not available, an operating system loads the dynamic module to memory at a different address (S54). Because the ROP attack makes a malicious code by combining code sections in a code area, attackers should find the code sections, and only if the dynamic module is loaded to the fixed address, the ROP attack may be applied. However, if every dynamic module is forcibly relocated to memory at a random address, the attacker may not find code sections for ROP attack. Therefore, it is possible to effectively defend the ROP attack.

Referring to FIGS. 1 to 11, a method for detecting a vulnerability attack in a program, which uses the detection device as described above, is configured as follows. The method for detecting a vulnerability attack in a program includes: a installation step (S1) in which the installation unit 1 loads the protection unit 2 in a process; a hooking processing step (S2) in which the hooking processing unit 41 of the protection unit 2 that is installed in the installation step (S1) suspends execution of a process by hooking a function when the process is executed and calls the specific function to perform a specific task; a information collecting step (S3) in which the information collecting unit 42 of the protection unit 2 checks a call stack of the function hooked in the hooking processing step (S2), and collects and outputs the call stack return address information; and diagnosis processing step (S4) in which, to prevent execution of a malicious code, the diagnosis processing unit 432 detects malicious behaviors by analyzing the call stack return address information output from the information collecting step (S3).

The installation step (S1) is a step in which the installation unit 1 loads the protection unit 2 in a process. In the installation step (S1), using a callback routine, the installation unit 1 installs the protection unit 2 after the process is created but in a state that the process is not executed.

In the hooking processing step (S2), when the process is executed and calls a specific function to perform a specific task, the hooking processing unit 41 of the protection unit 2 that is installed in the installation step (S1) suspends execution of the process by hooking the function.

In the information collecting step (S3), the information collecting unit 42 of the protection unit 2 checks a call stack of the function hooked in the hooking processing step (S2), and collects and outputs the call stack return address information. The call stack return address information includes: a return address of every function located on the function call mutes in which the hooked function is called; an attribute of memory in which the return address is included (for example, protection right of memory, status values, etc.); module names (for example, hwp, exe, dll); Imagebase address for loading a dynamic module; and the like.

In the diagnosis processing step (S4), to prevent execution of a malicious code, the diagnosis processing unit 432 of the protection unit 2 detects a malicious behavior by analyzing the call stack return address information that is output from the information collecting step (S3). The diagnosis processing step (S4) includes a first diagnosis step (S41), a second diagnosis step (S42), a process termination step (S43), and a process execution step (S44).

In the first diagnosis step (S41), the first diagnosis unit 432a of the diagnosis processing unit 432 analyzes the call stack return address information and determines whether the return address is in a code area. If the return address is not in a code area, it is determined that there is a malicious behavior.

In the second diagnosis step (S42), the second diagnosis unit 432b of the diagnosis processing unit 432 analyzes the call stack return address information and determines whether a previous instruction of the instruction that the return address indicates is a function call instruction. If the previous instruction of the instruction that the return address indicates is not a function call instruction, it is determined that there is a malicious behavior.

In the process termination step (S43), when it is determined in any of both the first diagnosis step (S41) and second diagnosis step (S42) that there is a malicious behavior, the processing unit 432c of the diagnosis processing unit 432 stores both the diagnosis information and a log file onto a disk and terminates the process so as not to execute any more codes.

In the process execution step (S44), when neither the first diagnosis unit 432a nor second diagnosis unit 432b detect a malicious behavior, the processing unit 432c of the diagnosis processing unit 432 resumes the suspended process.

A method for detecting a vulnerability attack in a program, according to another embodiment of the present invention, may further include a security configuration step (not illustrated), a filtering step (not illustrated), and a relocation step (not illustrated).

In the security configuration step, the security configuration unit 3 of the protection unit 2 that is installed in the installation step (S1) checks and configures a security state of a process before the hooking processing step (S2). The security configuration step includes a permanent DEP setting step and an address preemption step.

In the permanent DEP setting step, the permanent DEP setting unit 31 of the security configuration unit 3 enables permanent DEP on a process. The permanent DEP setting step includes a check step, an execution step, and the like.

In the check step, the check unit 311 of the permanent DEP setting unit 31 checks and enables DEP of an operating system.

In the execution step, when confirming that DEP of the operating system is enabled in the check step, the execution unit 312 of the permanent DEP setting unit 31 enables permanent DEP on a process to prevent execution of a code in a non-executable area of memory. If DEP is not enabled on the process, DEP is enabled in a state that the process has been created. If DEP is enabled on the process, DEP is disabled and then enabled on the process so as to enable permanent DEP that cannot be disabled by a malicious behavior.

In the address preemption step after the permanent DEP setting step, to defend a heap spray attack, the address preemption unit 32 of the security configuration unit 3 preempts an address of a heap area of normal memory, which is used for a malicious behavior. If the address of the heap area (Nop Sled), which is used for a malicious behavior by the heap spray attack, is preempted, execution of a malicious code may be prevented.

The filtering step is performed after the information collecting step (S3) but before the diagnosis processing step (S4). In the filtering step, the filtering unit 431 of the information determining unit 43 compares criteria for exception handling with the call stack return address information output from the information collecting step (S3). If the call stack return address information corresponds to the criteria for exception handling, the filtering unit 431 filters the information as an exception handling case of the diagnosis processing step (S4). In the filtering step, when a return address in call stack return address information is not in a normal memory, when a return address in call stack return address information is in a stack area of memory, when a return address in call stack return address information is in a whitelist, and when an attribute of a return address in call stack return address information is Write attribute, the exception handling is done.

In the relocation step, information about the function hooked in the hooking processing step (S2) (a function related to loading of a dynamic module) is analyzed, and a base address of a dynamic module is relocated in a function that loads the dynamic module. As shown in FIG. 10, the relocation unit 5 determines whether the relocation option of the dynamic module is enabled (S51). Then, if the relocation option is disabled, the function that loads the dynamic module collects the base address of the dynamic module (S52) and allocates memory at the base address (S53). Regardless of enabling the relocation option of the dynamic module, if the memory is not available, the operating system loads the dynamic module to memory at a different address (S54).

Although the embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A device for detecting a vulnerability attack in a program, comprising:
a hooking processing unit for suspending execution of a process by hooking a function when the process is executed and the function is called to perform a specific task;
an information collecting unit for collecting and outputting call stack return address information by checking a call stack of the function hooked by the hooking processing unit; and
an information determining unit for preventing execution of a malicious code by detecting a malicious behavior from analysis of the call stack return information that is output from the information collecting unit.

2. The device of claim 1, wherein the call stack return address information comprises:
a return address of every function located on every function call route that calls a hooked function; and
an attribute of memory that includes the return address.

3. The device of claim 2, wherein the information determining unit comprises:
a first diagnosis unit for determining by analyzing call stack return address information whether a return address is in a code area, and for determining that there is a malicious behavior when the return address is not in the code area; and
a second diagnosis unit for determining by analyzing the call stack return address information whether a previous instruction of an instruction that a return address indicates is a function call instruction, and for determining that there is a malicious behavior when the previous instruction of the instruction that the return address indicates is not a function call instruction.

4. The device of claim 3, wherein the information determining unit further comprises,
a processing unit for storing both diagnosis information and a log file in a disk and terminating a process so as not to execute any more codes when any one of both the first and second diagnosis unit detects a malicious behavior, and for resuming execution of the suspended process when neither the first nor second diagnosis unit detect a malicious behavior.

5. The device of claim 3, wherein the information determining unit further comprises:
a filtering unit for comparing criteria for exception handling with the call stack return address information output from the information collecting unit, and for skipping a determination of the first and second diagnosis unit when the call stack return address information corresponds to the criteria for exception handling,
the filtering unit doing exception handling when a return address of the call stack return address information is in memory that is not allocated in a process address space, when the return address of the call stack return address is in a stack area of memory, when the return address of the call stack return address information is in a whitelist, and when an attribute of the return address of the call stack return address information is Write attribute.

6. The device of claim 1, further comprising:
a security configuration unit for checking and configuring a security state of a process before execution of the process,
wherein the security configuration unit comprises:
a check unit for checking and enabling DEP of an operating system; and
an execution unit for enabling permanent DEP on a process to prevent execution of a code in a non-executable memory area when the check unit confirms that DEP of the operating system is enabled.

7. The device of claim 6, wherein the execution unit enables permanent DEP on a process, which cannot be disabled by a malicious behavior, by enabling DEP on the process in a state that the process is created if DEP is not enabled on the process, and by disabling and then enabling DEP if DEP is enabled on the process.

8. The device of claim 6, wherein the security configuration unit further comprises, an address preemption unit for preempting an address of a heap area, which is used for a malicious behavior by a heap spray attack.

9. The device of claim 1, further comprising:
a relocation unit for relocating in a function that loads a dynamic module, a base address of the dynamic module that is loaded in a process by analyzing information about the function hooked by the hooking processing unit,
the relocation unit determining whether a relocation option of the dynamic module is enabled, and when the relocation option is disabled, collecting the base address of the dynamic module from the function that loads the dynamic module and allocating memory at the base address.

10. A method for detecting a vulnerability attack in a program, comprising:
a hooking processing operation for suspending execution of a process by hooking a function when the process is executed and calls the function to perform a specific task;
an information collecting operation for collecting and outputting call stack return address information by checking a call stack of the function hooked by the hooking processing operation; and
a diagnosis processing operation for preventing execution of a malicious code by detecting a malicious behavior from analysis of the call stack return address information output from the information collecting operation.

11. The method of claim 10, wherein:
the call stack return address information includes a return address of every function located on every function call route that calls a hooked function, and an attribute of memory that includes the return address; and
the diagnosis processing operation comprises:
a first diagnosis operation for determining by analyzing call stack return address information whether a return address is in a code area, and for determining that there is a malicious behavior when the return address is not in the code area; and
a second diagnosis operation for determining by analyzing the call stack return address information whether a previous instruction of an instruction that a return address indicates is a function call instruction, and for determining that there is a malicious behavior when the previous instruction of the instruction that the return address indicates is not a function call instruction.

12. The method of claim 11, further comprising:
a filtering operation, before the diagnosis processing operation, for comparing criteria for exception handling with the call stack return address information output from the information collecting operation, and for skipping a determination of the diagnosis processing operation when the call stack return address information corresponds to the criteria for exception handling,
wherein in the filtering operation, exception handling is done when a return address of the call stack return address information is in memory that is not allocated in a process address space, when the return address of the call stack return address is in a stack area of memory, when the return address of the call stack return address information is in a whitelist, and when an attribute of the return address of the call stack return address information is Write attribute.

13. The method of claim 11, further comprising:
a security configuring operation for checking and configuring a security state of a process before the hooking processing operation,
wherein the security configuring operation further comprises:
a checking operation for checking and enabling DEP of an operating system;
an executing operation for enabling permanent DEP on a process to prevent execution of a code in a non-executable memory area when confirming in the checking operating that DEP of the operating system is enabled; and
an address preempting operation for preempting an address of a heap area, which is used for a malicious behavior by a heap spray attack, after permanent DEP is enabled in the executing operation,
wherein in the executing operation, permanent DEP, which cannot be disabled by a malicious behavior, is enabled on a process by enabling DEP on the process in a state that the process is created if DEP is not enabled on the process, and by disabling and then enabling DEP if DEP is enabled on the process.

14. The method of claim 10, further comprising:
a relocating operation for relocating a base address of a dynamic module loaded in a process by analyzing the function hooked by the hooking processing operation,
wherein in the relocating operation, whether a relocation option of the dynamic module is enabled is determined, and when the relocation option is disabled, the base address of the dynamic module is collected from the function that loads the dynamic module and memory at the base address is allocated.
